(19) United States
(12) Patent Application Publication
(10) Pub. No.: US 2025/0259409 A1
(43) Pub. Date: Aug. 14, 2025

(54) Neural Network for Identifying Regions of Interest in Luminescent Images

(71) Applicant: Sanofi, PARIS (FR)

(72) Inventors: Thibaud De-Gallier, Paris (FR); Stéphane Guerif, Paris (FR); Erwan Jouannot, Paris (FR); Etienne Pochet, Paris (FR); Elton Rexhepaj, Paris (FR); Roger Trullo, Paris (FR)

(21) Appl. No.: 18/833,067

(22) PCT Filed: Jan. 24, 2023
(86) PCT No.: PCT/EP2023/051634

§ 371 Date: Jul. 25, 2024

(30) Foreign Application Priority Data
Jan. 27, 2022 (EP) 22315024.4

(51) Int. Cl. G06V 10/25; G06T 3/40; G06T 7/12; G06V 10/46; G06V 10/771; G06V 10/82

(52) U.S. Cl. CPC G06V 10/25; G06T 3/40; G06T 7/12; G06V 10/46; G06V 10/771; G06V 10/82

(57) ABSTRACT

An example embodiment includes a computer implemented method comprising receiving paired images of a subject, comprising an image of the subject and a luminescent image of the subject; generating, using a first machine-learned model and from the image of the subject, coordinates of a bounding box around the subject in the image; extracting, based on the coordinates of the bounding box around the subject, a pair of cropped images, comprising a cropped image of the subject and a cropped luminescent image of the subject; and generating, using a second machine learning model, parameters of a bounding shape identifying the region of interest.

### CROSS REFERENCE TO RELATED APPLICATIONS

The present application is the national stage entry of International Patent Application No. PCT/EP2023/051634, filed on Jan. 24, 2023, and claims priority to Application No. EP 22315024.4, filed on Jan. 27, 2022, the disclosures of which are incorporated herein by reference.

### TECHNICAL FIELD

This specification relates to use of machine learning models to identify regions of interest in luminescent images, such as bioluminescent images or fluorescent images.

### BACKGROUND

Bioluminescence imaging (BLI) and Fluorescent Imaging (FLI) are technologies for in vivo imaging that allows for the non-invasive study of ongoing biological processes, e.g. tumor evolution, drug efficacy, cell tracking, target engagement etc. BLI and FLI have widespread applications and may for example be used in the study of cancer therapeutics in disseminated models such as Acute Myeloid Lymphoma with typical lesions within bone (e.g. long bones, vertebra, skull bone), Immuno-Oncology, tracking of T-cells and NK cells and in mRNA delivery understanding. These technologies may also be used in cellular imaging and in other in vitro imaging techniques.

At present, Regions Of Interest (ROIs) are manually drawn on images using specialized software in order to quantify the signal intensity and to evaluate biological activity of drugs on the transfected cells and/or labelled cells. This is a very time-consuming process for large studies with potential inter-operator variability accuracy in ROI identification, particularly where multiple people perform the analysis of the images. There is therefore a need to provide an accurate way of identifying regions of interest in luminescent images which is less time consuming and provides a more consistent identification of ROIs.

### SUMMARY

According to a first aspect of this specification, there is described a computer implemented method of identifying one or more regions of interest in an image, the method comprising receiving a pair of images of a subject, the pair of images comprising an image of the subject and a luminescent image of the subject; generating, using a first machine-learned model and from the image of the subject, coordinates of a bounding box around the subject in the image; extracting, from the image of the subject and the luminescent image of the subject and based on the coordinates of the bounding box around the subject, a pair of cropped images, the pair of images comprising a cropped image of the subject and a cropped luminescent image of the subject; and generating, using a second machine learning model and from the pair of cropped images, parameters of a bounding shape identifying the region of interest, wherein the second machine learning model is a neural network comprising one or more convolutional layers configured to generate a first feature map encoding features of the cropped image and a second feature map encoding features of the cropped luminescent image; and one or more fully connected layers configured to transform the first feature map and the second feature map into the parameters of the bounding shape identifying the region of interest.

The method may further comprise, after applying the first neural network, using a thresholding algorithm to produce a mask which identifies contours of the subject within the bounding box.

The second machine learning model may further comprise one or more residual connections. The parameters of a bounding shape may comprise parameters of an ellipse or circle. The parameters of the ellipse may be: (i) the x axis position of the centre point; (ii) the y axis position of the centre point; (iii) the length of the semi-minor axis; (iv) the length of the semi-major axis; and (v) the angle of rotation of the ellipse from vertical. The subject may be an animal, such as a mouse.

The method may further comprise selecting a region of interest category from a list of anatomical regions, wherein the second machine learning model corresponds to the selected region of interest category.

The method may comprise, prior to generating the first feature map and the second feature map, checking if the image and the luminescent image are of a predetermined size, and if not, resizing the image and the luminescent image to the predetermined size.

The method may further comprise displaying the image of the subject and/or the luminescent image of the subject with the region of interest indicated.

The image may be a photographic image of the subject. The method may further comprise, prior to transforming the first feature map and the second feature map, concatenating the first and second feature maps.

According to a second aspect of this specification, there is described a computer implemented method of training a model for identifying one or more regions of interest in an image, the method comprising for each of a plurality of training samples, each training sample comprising: a training pair comprising an image of a subject and a luminescent image of the subject; and ground truth parameters of a bounding shape identifying a region of interest of the subject generating, using a neural network and from a respective training pair, candidate parameters of a bounding shape identifying the region of interest; and comparing the candidate parameters of the bounding shape to corresponding ground truth parameters of the bounding shape of the training sample; and updating parameters of the neural network based on the comparisons, wherein the neural network comprises one or more convolutional layers configured to generate a first feature map encoding features of the image and a second feature map encoding features of the luminescent image; and one or more fully connected layers configured to transform the first feature map and the second feature map into candidate parameters of a bounding shape identifying the region of interest.

Comparing the candidate parameters of the bounding shape to corresponding ground truth parameters of the bounding shape of the training sample may comprise evaluating a loss function; and updating parameters of the neural network based on the comparisons may comprise applying an optimisation routine to the loss function.

According to a third aspect of this specification, there is described a computer program product comprising computer-readable code that, when executed by a computing system, causes the computing system to perform a method according to the first aspect or the second aspect.

According to a third aspect of this specification, there is described a system comprising one or more processors and a memory, the memory storing computer readable instructions that, when executed by the one or more processors, causes the system to perform a method according to the first aspect or the second aspect.

### BRIEF DESCRIPTION OF THE FIGURES

Embodiments will now be described by way of non-limiting examples with reference to the accompanying drawings, in which:

FIG. 1 depicts a schematic overview of an example method for identifying regions of interest in luminescent images.

FIG. 2 depicts a schematic representation of a convolutional neural network for generating feature maps from the input images.

FIG. 3a depicts a photographic image containing five mice with annotated regions of interest.

FIG. 3b depicts a bioluminescent image of the same five mice as in FIG. 3a.

FIG. 4 depicts the result of an additional contouring step which may be performed on the images.

FIG. 5 depicts a flowchart of an example method of identifying regions of interest in luminescent images.

FIG. 6 depicts a flowchart of an example method of training a model for identifying regions of interest in luminescent images.

FIG. 7 depicts a schematic example of a system/apparatus for performing any of the methods described herein.

### DETAILED DESCRIPTION

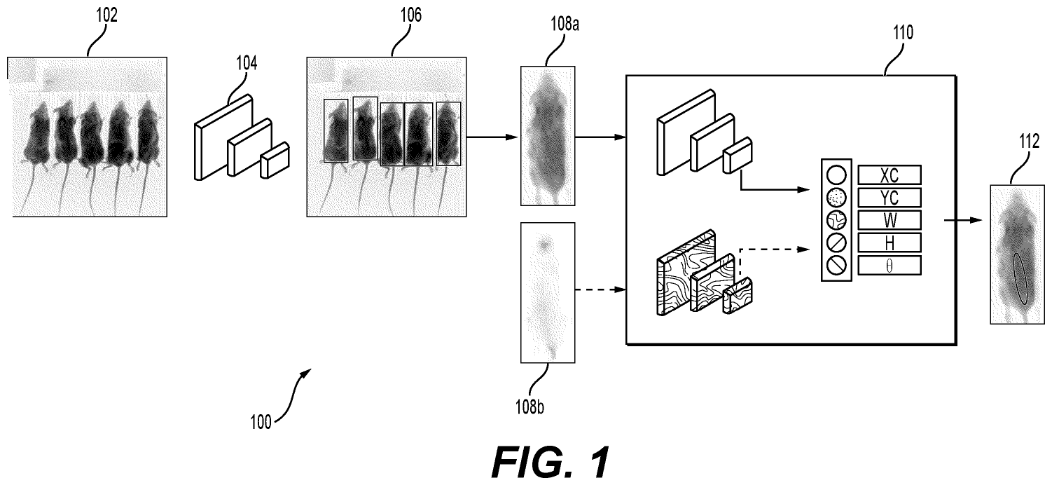

FIG. 1 depicts a schematic overview of a method 100 for identifying regions of interest in luminescent images. The term luminescent image is used herein to mean an image containing at least one subject exhibiting some form of luminescence, such as, but not limited to, bioluminescence or fluorescence. A first input image 102 is input into a first machine-learned model 104. The first input image may comprise pixel data arranged in an array, and comprise one or more colour channels (e.g. RBG channels or a grayscale colour channel). The first input image 102 may, for example, be a grayscale digital photograph.

The first input image 102 contains one or more subjects to be analysed. In the example of FIG. 1, the first input image 102 is of several mice into which a bioluminescent or fluorescent substance has been injected, with each subject being a single mouse. However, the techniques described herein are applicable in many different scenarios and in a wide range of living organisms, such as plants, animals, fungus, bacteria and viruses. In some examples, an image of an individual mouse may be provided as the input image.

The first machine-learned model 104 processes the first input image 102 to determine a bounding box for one or more of the subjects in the first input image 102. The first machine-learned model 104 may be any suitable type of machine-learned bounding box model. The first machine-learned model 104 may in some examples be a fine-tuned Faster-RCNN. The initial weights for this model can be obtained by training on the COCO Dataset. The weights can then be updated by training on a more specific dataset. The first input image 102 may be a grayscale photograph, with pixel values scaled between 0 and 1 before model computations. The first machine-learned model 104 may output a result image 106 in which each of the subjects in the image is identified with a rectangular bounding box. Alternatively, the first machine learning model 104 may output co-ordinates of one or more bounding boxes in the first input image 102, each bounding box corresponding to one subject in the first input image. The co-ordinates of each bounding box generated by the first machine-learned model 104 are used to extract a pair of cropped images (108a, 108b). The pair of cropped images (108a, 108b) comprise a cropped image of the subject 108a and a cropped luminescent image of the subject 108b. The cropped image 108a of the subject is cropped from the first input image 102.

The cropped luminescent image of the subject 108b is obtained by applying the co-ordinates of a bounding box generated by the first machine-learned model 104 to a second input image (not shown) of the same subject or subjects, captured by a sensitive CCD camera capable of detecting the bioluminescence or fluorescence emission signal.

The pair of cropped images (108a, 108b) are then input into a machine learning model 110 which outputs the parameters of a bounding shape. The machine learning model 110 is a neural network having one or more convolutional layers. In some embodiments, such as the embodiment shown, independent heads are used to input the cropped image of the subject 108a and the cropped luminescent image of the subject 108b. The cropped image of the subject 108a may be processed using a first sub-network, while the cropped luminescent image of the subject 108b may be processed by a second sub-network.

In some implementations, the cropped images 108a, 108b are resized/rescaled to a pre-determined size prior to input into the machine learning model 110. Typically, bounding boxes of the subjects may vary in size depending on, for example, the subject size and pose. Consequently, the cropped images may vary in size. However, the machine learning model 110 may, in some embodiments, accept inputs of a pre-determined, fixed size (e.g. n×m pixels). The cropped images 108a, 108b are therefore resized to this fixed input size. Interpolation techniques may be used to perform the rescaling to fill in any missing pixel data.

The machine learning model 110 may be specific to a particular anatomical feature of the subject in the images. For example, multiple different machine learning models 110 may be available which been trained to identify regions of interest in the head, vertebrae or posterior legs of the subject or in particular internal organs of the subject (e.g. Liver, lungs, spleen, etc.). Part of the method may include selecting a particular machine learning model to use corresponding to the anatomical feature of interest. Alternatively, the machine learning model may be of general applicability and be configured to identify regions of interest in the luminescent images, wherever they are located on the subject.

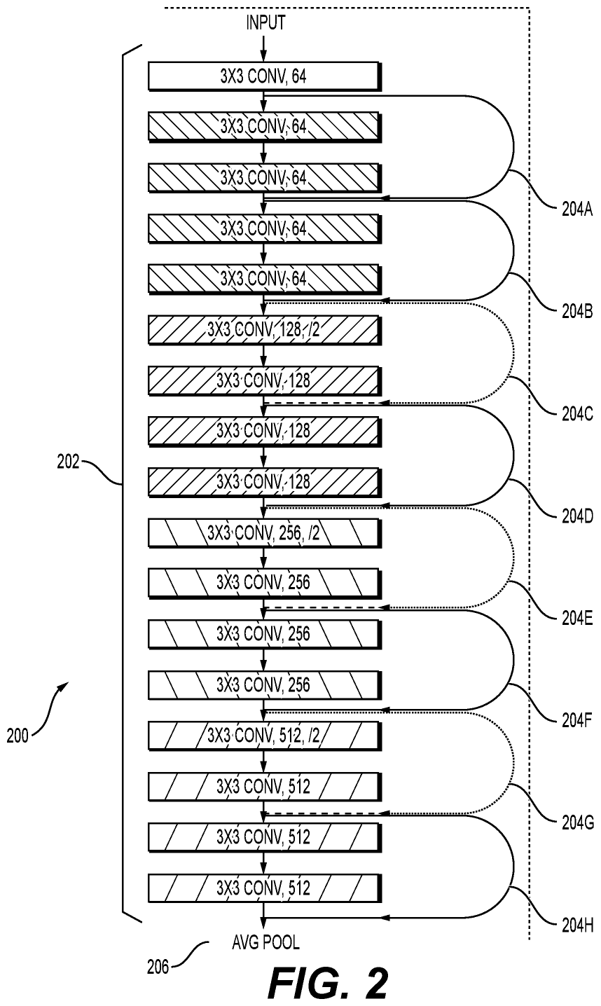

Each sub-network of the machine learning model 110 may comprise a ResNet backbone, such as the ResNet18 backbone (i.e. 18 convolutional blocks with 3×3 filters with residual connections in between) as shown in FIG. 2. The machine learning model 110 generates a first feature map encoding features of the cropped image and a second feature map encoding features of the cropped luminescent image. The first and second feature maps may, for example, each be 512-d feature maps, though it will be appreciated that many other feature map dimensions are possible.

The machine learning model 110 further comprises one or more fully connected layers configured to transform the first feature map and the second feature map into parameters of a bounding shape identifying the region of interest. In this manner, information from both the photographic image of the subject and the luminescent image of the subject is taken into account in identifying the region of interest. Before being transformed into the parameters of a bounding shape, the first and second feature maps may be combined, for example by being concatenated or stacked. Where the first and second feature maps are 512-d features maps, the concatenated feature maps may be a 1024-d feature map.

The bounding shape is defined by the parameters output by the one or more fully connected layers of the machine learning model 110. Where there are several different machine learning models corresponding to different anatomical features of the subject, different bounding shapes may be output for each model. In some examples the bounding shape is an ellipse. The ellipse may be described by five parameters: (i) the x axis position of the centre point, (ii) the y axis position of the centre point, (iii) the length of the semi-minor axis, (iv) the length of the semi-major axis and (v) the angle of rotation of the ellipse from vertical. It will however be appreciated that there are other ways of defining an ellipse which may be used.

The bounding shape may then be displayed on the cropped image of the subject 108a as shown in output image 112 in FIG. 1, on the cropped luminescent image of the subject 108b and/or on a combined image showing both the photographic and luminescent paired images overlaid.

FIG. 2 depicts a schematic representation of a convolutional neural network 200 for generating feature maps from the input images. As described above the cropped image of the subject 108a and the cropped luminescent image of the subject 108b may each be input into a subnetwork comprising a convolution neural network, before one or more fully connected layers of the neural network transform the resulting feature maps into the parameters of the bounding shape identifying the region of interest. The subnetwork may, for example, be the convolutional neural network 200 as represented in FIG. 2.

The convolutional neural network 200 comprises a sequence of convolutional layers 202, each configured to apply a respective plurality of convolutional filters to their respective inputs. In the example shown, each convolutional filter is a 3×3 convolutional filter, though it will be appreciated that convolutional filters of other sizes may alternatively or additionally be applied.

The convolutional neural network 200 further comprises on or more skip connections 204A-H (also referred to as “residual connections”). A skip connection 204A-H takes the output of a convolutional layer and uses it as part of the input into a subsequent, non-consecutive layer of the network, i.e. it skips one or more convolutional layers. In some embodiments, the input of a convolutional layer at the end of a skip connection comprises a combination of the output of immediately preceding layer and the output linked by the skip connection. For example, the output of immediately preceding layer may be added to the output linked by the skip connection.

The convolutional neural network 200 may further comprise one or more average pooling layers 206. Average pooling layers 206 generate a lower dimensional output from their input by averaging over patches of their input.

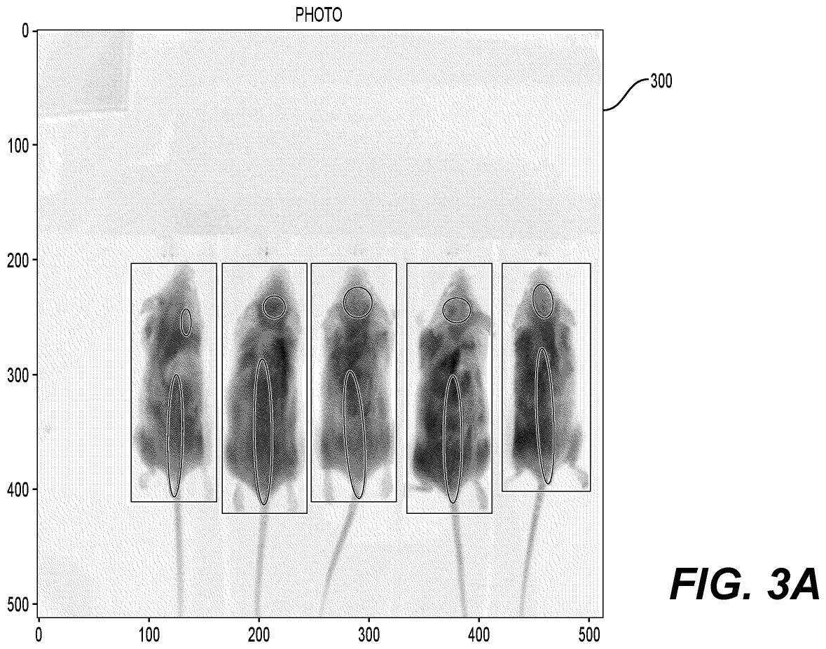

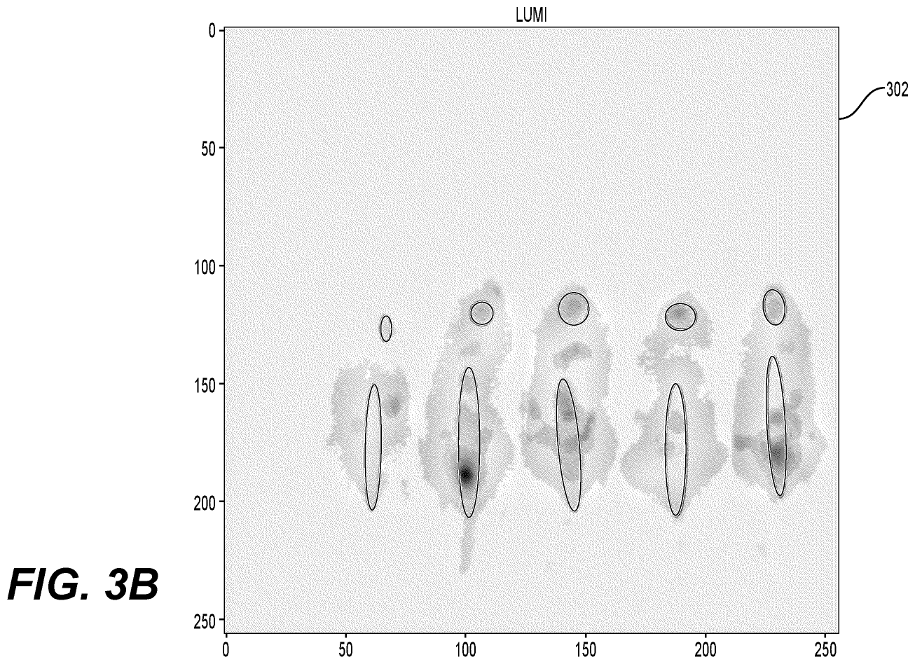

FIG. 3a depicts a photographic image 300 containing five mice while FIG. 3b shows a luminescent image 302 of the same five mice. The results of the first machine-learned model and second machine learning model are shown in the images. In particular, a bounding box has been generated for each mouse and two different regions of interest (along the vertebra and the head) have been identified with ellipses for each mouse. The bounding boxes are omitted in FIG. 3b. Although the second machine learning model takes as its input paired images of a single subject, the original arrangement of multiple subjects may be reconstituted after the parameters of the bounding shape identifying the region of interest have been output for each subject. This may be advantageous where the subjects have been treated in the same manner and a visual side-by-side comparison of the subjects is potentially beneficial.

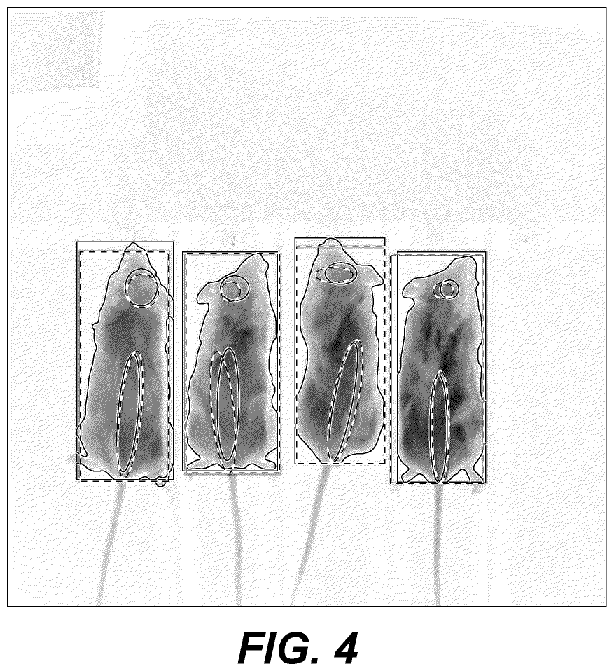

FIG. 4 depicts the result of an additional contouring step which may be performed to improve the precision with which the regions of interest can be identified. After the first machine-learned model has generated the coordinates of the bounding box around the subject in the image, the additional processing step may be performed to obtain the contour of the subject in the image. A thresholding algorithm is applied to produce a mask. This mask is refined by a sequence of morphological operations which may include one or more of removing small objects, morphological closing and filling small holes. FIG. 4 also shows a comparison between manual annotations (in green) and the regions of interest identified by the method described herein, as well as the additional contouring (in red).

The additional contouring information is not passed to the second machine learning model, but is displayed and used in the downstream analysis by the scientists in the same way as the generated ellipses. The contouring informant can be considered as an additional ROI.

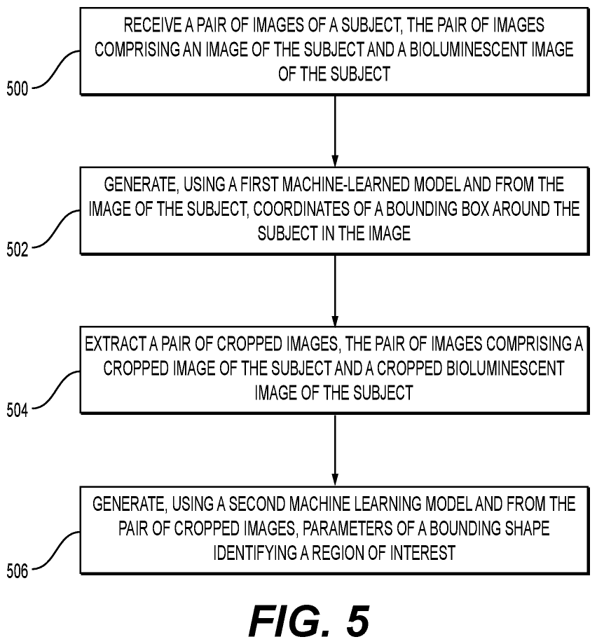

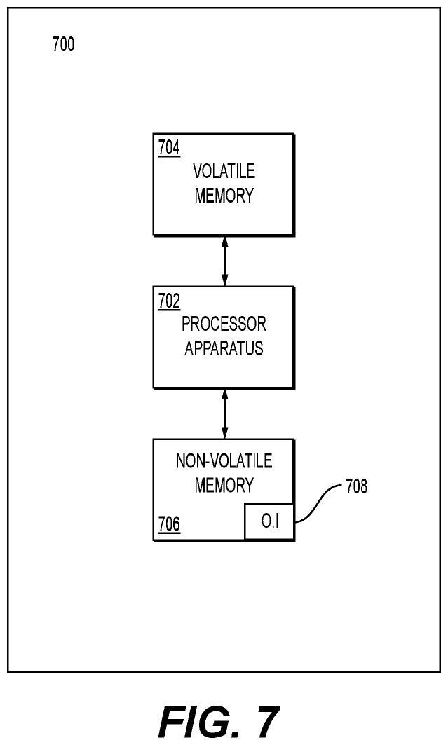

FIG. 5 depicts a flowchart of an example method of identifying one or more regions of interest in an image. The method may be performed by a computing system, such as the system described in relation to FIG. 7.

At step 500 a pair of images of a subject is received. The pair of images comprises an image of the subject and a luminescent image of the same subject. These two images may have been captured simultaneously or consecutively at any time before the method is performed. The subject in the image and luminescent image may be a living organism.

At step 502 a first machine-learned model is used to generate coordinates of a bounding box around the subject in the image. This step is performed using the image of the subject. The coordinates of the bounding box may then be applied to both the image of the subject and the luminescent image of the subject to produce a pair of images of the same subject. This step is primarily to limit the image area input to the second machine learning model to the subject of interest. However, this step may also be used to separate an input image comprising multiple subjects into multiple images comprising one subject each. As shown in FIGS. 3, the original image may contain multiple subjects. Such an image may be input into the first machine-learned model, which will generate a bounding box around each of the subjects in the image.

Optionally, between steps 502 and 504 an additional step of using a thresholding algorithm to produce a mask which identifies contours of the subject within the bounding box may be performed. Example of thresholding algorithms that may be used are described in “Minimum Cross Entropy Thresholding” (Li C. H. and Lee C. K. (1993) Pattern Recognition, 26 (4): 617-625) and “An Iterative Algorithm for Minimum Cross Entropy Thresholding” (Li C. H. and Tam P. K. S. (1998) Pattern Recognition Letters, 18 (8): 771-776), the contents of which are incorporated herein by reference.

At step 504 a pair of cropped images is extracted from the image of the subject and the luminescent image of the subject. This extraction is based on the coordinates of the bounding box around the subject. The pair of images therefore comprise a cropped image of the subject and a cropped luminescent image of the subject.

At step 506 a second machine learning model is used to generate, from the pair of cropped images, parameters of a bounding shape identifying a region of interest. The second machine learning model is a neural network and comprises (i) one or more convolutional layers configured to generate a first feature map encoding features of the cropped image and a second feature map encoding features of the cropped luminescent image; and (ii) one or more fully connected layers configured to transform the first feature map and the second feature map into the parameters of the bounding shape identifying the region of interest.

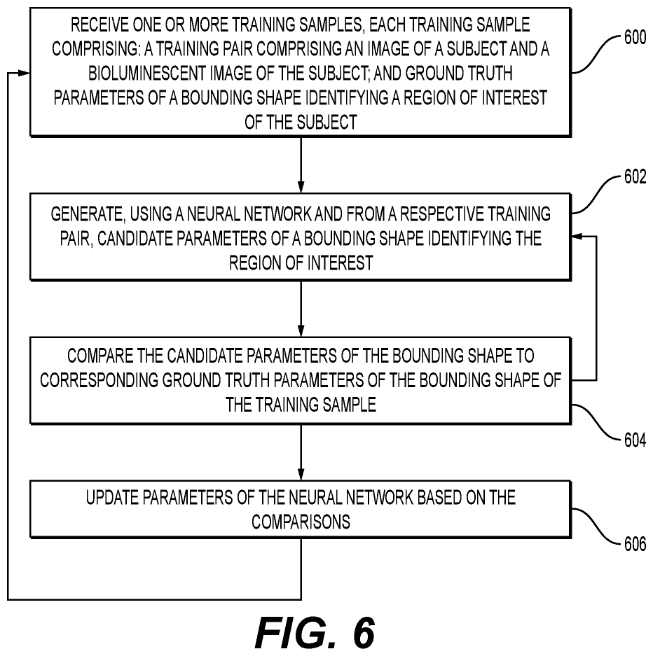

FIG. 6 depicts a flowchart of an example method of training a model for identifying regions of interest in luminescent images. The method may be performed by a computing system, such as the system described in relation to FIG. 7.

At step 600, one or more training samples is received, each training sample comprising a training pair comprising an image of a subject and a luminescent image of the subject and ground truth parameters of a bounding shape identifying a region of interest of the subject. The raw training images may contain several subjects per image, where each subject in the image has a bounding box and one or more regions of interest identified. As a precursor to step 600, the multiple subjects in the image may be isolated so that the model is trained on one subject and associated ground truth parameters of a bounding shape at a time.

At step 602, a neural network is used to generate, from a respective training pair, candidate parameters of a bounding shape identifying the region of interest. The neural network is described above in relation to FIGS. 1 and 2 and comprises one or more convolutional layers configured to generate a first feature map encoding features of the image and a second feature map encoding features of the luminescent image, and one or more fully connected layers configured to transform the first feature map and the second feature map into candidate parameters of a bounding shape identifying the region of interest.

At step 604, the candidate parameters of the bounding shape are compared to corresponding ground truth parameters of the bounding shape of the training sample.

Comparing the candidate parameters of the bounding shape to corresponding ground truth parameters of the bounding shape of the training sample may comprise evaluating a loss function, such as an L2 or L1 loss between the candidate parameters and corresponding ground truth parameters.

Steps 602 and 604 are iterated over the one or more training samples until candidate parameters of the bounding shape for each of the training samples has been determined.

At step 606, parameters of the neural network are updated based on the comparisons. Updating parameters of the neural network based on the comparisons may comprise applying an optimisation routine to the loss function. Such optimisation routines may comprise, but are not limited to, stochastic gradient descent routines. Steps 600 to 606 are iterated over the training dataset until a threshold condition is satisfied. The threshold condition may be a threshold number of training epochs and/or a threshold performance on a validation dataset.

FIG. 7 depicts a schematic example of a system/apparatus 700 for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 700 comprises one or more processors 702. The one or more processors control operation of other components of the system/apparatus 700. The one or more processors 702 may, for example, comprise a general-purpose processor. The one or more processors 702 may be a single core device or a multiple core device. The one or more processors 702 may comprise a Central Processing Unit (CPU) or a graphical processing unit (GPU). Alternatively, the one or more processors 702 may comprise specialised processing hardware, for instance a RISC processor or programmable hardware with embedded firmware. Multiple processors may be included.

The system/apparatus comprises a working or volatile memory 704. The one or more processors may access the volatile memory 704 in order to process data and may control the storage of data in memory. The volatile memory 704 may comprise RAM of any type, for example, Static RAM (SRAM), Dynamic RAM (DRAM), or it may comprise Flash memory, such as an SD-Card.

The system/apparatus comprises a non-volatile memory 706. The non-volatile memory 706 stores a set of operation instructions 708 for controlling the operation of the processors 702 in the form of computer readable instructions. The non-volatile memory 706 may be a memory of any kind such as a Read Only Memory (ROM), a Flash memory or a magnetic drive memory.

The one or more processors 702 are configured to execute operating instructions 708 to cause the system/apparatus to perform any of the methods described herein. The operating instructions 708 may comprise code (i.e. drivers) relating to the hardware components of the system/apparatus 700, as well as code relating to the basic operation of the system/apparatus 700. Generally speaking, the one or more processors 702 execute one or more instructions of the operating instructions 708, which are stored permanently or semi-permanently in the non-volatile memory 706, using the volatile memory 704 to store temporarily data generated during execution of said operating instructions 708.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 7, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the present disclosure can be implemented and/or supplied and/or used independently.

Although several embodiments have been shown and described, it would be appreciated by those skilled in the art that changes may be made in these embodiments without departing from the principles of this disclosure, the scope of which is defined in the claims and their equivalents.

The terms “drug” or “medicament” are used synonymously herein and describe a pharmaceutical formulation containing one or more active pharmaceutical ingredients or pharmaceutically acceptable salts or solvates thereof, and optionally a pharmaceutically acceptable carrier. An active pharmaceutical ingredient (“API”), in the broadest terms, is a chemical structure that has a biological effect on humans or animals. In pharmacology, a drug or medicament is used in the treatment, cure, prevention, or diagnosis of disease or used to otherwise enhance physical or mental well-being. A drug or medicament may be used for a limited duration, or on a regular basis for chronic disorders.

As described below, a drug or medicament can include at least one API, or combinations thereof, in various types of formulations, for the treatment of one or more diseases. Examples of API may include small molecules having a molecular weight of 500 Da or less; polypeptides, peptides and proteins (e.g., hormones, growth factors, antibodies, antibody fragments, and enzymes); carbohydrates and polysaccharides;

and nucleic acids, double or single stranded DNA (including naked and cDNA), RNA, antisense nucleic acids such as antisense DNA and RNA, small interfering RNA (SiRNA), ribozymes, genes, and oligonucleotides. Nucleic acids may be incorporated into molecular delivery systems such as vectors, plasmids, or liposomes. Mixtures of one or more drugs are also contemplated.

The drug or medicament may be contained in a primary package or “drug container” adapted for use with a drug delivery device. The drug container may be, e.g., a cartridge, syringe, reservoir, or other solid or flexible vessel configured to provide a suitable chamber for storage (e.g., short- or long-term storage) of one or more drugs. For example, in some instances, the chamber may be designed to store a drug for at least one day (e.g., 1 to at least 30 days). In some instances, the chamber may be designed to store a drug for about 1 month to about 2 years. Storage may occur at room temperature (e.g., about 20° C.), or refrigerated temperatures (e.g., from about-4° C. to about 4° C.). In some instances, the drug container may be or may include a dual-chamber cartridge configured to store two or more components of the pharmaceutical formulation to-be-administered (e.g., an API and a diluent, or two different drugs) separately, one in each chamber. In such instances, the two chambers of the dual-chamber cartridge may be configured to allow mixing between the two or more components prior to and/or during dispensing into the human or animal body.

For example, the two chambers may be configured such that they are in fluid communication with each other (e.g., by way of a conduit between the two chambers) and allow mixing of the two components when desired by a user prior to dispensing. Alternatively or in addition, the two chambers may be configured to allow mixing as the components are being dispensed into the human or animal body.

The drugs or medicaments contained in the drug delivery devices as described herein can be used for the treatment and/or prophylaxis of many different types of medical disorders. Examples of disorders include, e.g., diabetes mellitus or complications associated with diabetes mellitus such as diabetic retinopathy, thromboembolism disorders such as deep vein or pulmonary thromboembolism. Further examples of disorders are acute coronary syndrome (ACS), angina, myocardial infarction, cancer, macular degeneration, inflammation, hay fever, atherosclerosis and/or rheumatoid arthritis. Examples of APIs and drugs are those as described in handbooks such as Rote Liste 2014, for example, without limitation, main groups 12 (anti-diabetic drugs) or 86 (oncology drugs), and Merck Index, 15th edition.

Examples of APIs for the treatment and/or prophylaxis of type 1 or type 2 diabetes mellitus or complications associated with type 1 or type 2 diabetes mellitus include an insulin, e.g., human insulin, or a human insulin analogue or derivative, a glucagon-like peptide (GLP-1), GLP-1 analogues or GLP-1 receptor agonists, or an analogue or derivative thereof, a dipeptidyl peptidase-4 (DPP4) inhibitor, or a pharmaceutically acceptable salt or solvate thereof, or any mixture thereof. As used herein, the terms “analogue” and “derivative” refers to a polypeptide which has a molecular structure which formally can be derived from the structure of a naturally occurring peptide, for example that of human insulin, by deleting and/or exchanging at least one amino acid residue occurring in the naturally occurring peptide and/or by adding at least one amino acid residue. The added and/or exchanged amino acid residue can either be codeable amino acid residues or other naturally occurring residues or purely synthetic amino acid residues. Insulin analogues are also referred to as “insulin receptor ligands”. In particular, the term “derivative” refers to a polypeptide which has a molecular structure which formally can be derived from the structure of a naturally occurring peptide, for example that of human insulin, in which one or more organic substituent (e.g. a fatty acid) is bound to one or more of the amino acids. Optionally, one or more amino acids occurring in the naturally occurring peptide may have been deleted and/or replaced by other amino acids, including non-codeable amino acids, or amino acids, including non-codeable, have been added to the naturally occurring peptide.

Examples of insulin analogues are Gly(A21), Arg(B31), Arg(B32) human insulin (insulin glargine); Lys(B3), Glu(B29) human insulin (insulin glulisine); Lys(B28), Pro(B29) human insulin (insulin lispro); Asp(B28) human insulin (insulin aspart); human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Examples of insulin derivatives are, for example, B29-N-myristoyl-des(B30) human insulin, Lys(B29) (N-tetradecanoyl)-des(B30) human insulin (insulin detemir, Levemir®); B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N—(N-palmitoyl-gamma-glutamyl)-des(B30) human insulin, B29-N-omega-carboxypentadecanoyl-gamma-L-glutamyl-des(B30) human insulin (insulin degludec, Tresiba®); B29-N—(N-lithocholyl-gamma-glutamyl)-des(B30) human insulin; B29-N-(ω-carboxyheptadecanoyl)-des(B30) human insulin and B29-N-(ω-carboxyheptadecanoyl) human insulin.

Examples of GLP-1, GLP-1 analogues and GLP-1 receptor agonists are, for example, Lixisenatide (LYXUMIA®), Exenatide (Exendin-4, BYETTA®, BYDUREON®, a 39 amino acid peptide which is produced by the salivary glands of the Gila monster), Liraglutide (VICTOZA®), Semaglutide, Taspoglutide, Albiglutide (SYNCRIA®), Dulaglutide (TRULICITY®), rExendin-4, CJC-1134-PC, PB-1023, TTP-054, Langlenatide/HM-11260C (Efpeglenatide), HM-15211, CM-3, GLP-1 Eligen, ORMD-0901, NN-9423, NN-9709, NN-9924, NN-9926, NN-9927, Nodexen, Viador-GLP-1, CVX-096, ZYOG-1, ZYD-1, GSK-2374697, DA-3091 MAR-701, MAR709, ZP-2929, ZP-3022, ZP-DI-70, TT-401 (Pegapamodtide), BHM-034. MOD-6030, CAM-2036, DA-15864, ARI-2651, ARI-2255, Tirzepatide (LY3298176), Bamadutide (SAR425899), Exenatide-XTEN and Glucagon-Xten.

An example of an oligonucleotide is, for example: mipomersen sodium (KYNAMRO®), a cholesterol-reducing antisense therapeutic for the treatment of familial hypercholesterolemia or RG012 for the treatment of Alport syndrome.

Examples of DPP4 inhibitors are Linagliptin, Vildagliptin, Sitagliptin, Denagliptin, Saxagliptin, Berberine.

Examples of hormones include hypophysis hormones or hypothalamus hormones or regulatory active peptides and their antagonists, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, and Goserelin.

Examples of polysaccharides include a glucosaminoglycane, a hyaluronic acid, a heparin, a low molecular weight heparin or an ultra-low molecular weight heparin or a derivative thereof, or a sulphated polysaccharide, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium. An example of a hyaluronic acid derivative is Hylan G-F 20 (SYNVISC®), a sodium hyaluronate.

The term “antibody”, as used herein, refers to an immunoglobulin molecule or an antigen-binding portion thereof. Examples of antigen-binding portions of immunoglobulin molecules include F(ab) and F(ab′)2 fragments, which retain the ability to bind antigen. The antibody can be polyclonal, monoclonal, recombinant, chimeric, de-immunized or humanized, fully human, non-human, (e.g., murine), or single chain antibody. In some embodiments, the antibody has effector function and can fix complement. In some embodiments, the antibody has reduced or no ability to bind an Fc receptor. For example, the antibody can be an isotype or subtype, an antibody fragment or mutant, which does not support binding to an Fc receptor, e.g., it has a mutagenized or deleted Fc receptor binding region. The term antibody also includes an antigen-binding molecule based on tetravalent bispecific tandem immunoglobulins (TBTI) and/or a dual variable region antibody-like binding protein having cross-over binding region orientation (CODV).

The terms “fragment” or “antibody fragment” refer to a polypeptide derived from an antibody polypeptide molecule (e.g., an antibody heavy and/or light chain polypeptide) that does not comprise a full-length antibody polypeptide, but that still comprises at least a portion of a full-length antibody polypeptide that is capable of binding to an antigen. Antibody fragments can comprise a cleaved portion of a full length antibody polypeptide, although the term is not limited to such cleaved fragments. Antibody fragments that are useful in the present invention include, for example, Fab fragments, F(ab′)2 fragments, scFv (single-chain Fv) fragments, linear antibodies, monospecific or multispecific antibody fragments such as bispecific, trispecific, tetraspecific and multispecific antibodies (e.g., diabodies, triabodies, tetrabodies), monovalent or multivalent antibody fragments such as bivalent, trivalent, tetravalent and multivalent antibodies, minibodies, chelating recombinant antibodies, tribodies or bibodies, intrabodies, nanobodies, small modular immunopharmaceuticals (SMIP), binding-domain immunoglobulin fusion proteins, camelized antibodies, and VHH containing antibodies. Additional examples of antigen-binding antibody fragments are known in the art.

The terms “Complementarity-determining region” or “CDR” refer to short polypeptide sequences within the variable region of both heavy and light chain polypeptides that are primarily responsible for mediating specific antigen recognition. The term “framework region” refers to amino acid sequences within the variable region of both heavy and light chain polypeptides that are not CDR sequences, and are primarily responsible for maintaining correct positioning of the CDR sequences to permit antigen binding. Although the framework regions themselves typically do not directly participate in antigen binding, as is known in the art, certain residues within the framework regions of certain antibodies can directly participate in antigen binding or can affect the ability of one or more amino acids in CDRs to interact with antigen. Examples of antibodies are anti PCSK-9 mAb (e.g., Alirocumab), anti IL-6 mAb (e.g., Sarilumab), and anti IL-4 mAb (e.g., Dupilumab).

Pharmaceutically acceptable salts of any API described herein are also contemplated for use in a drug or medicament in a drug delivery device. Pharmaceutically acceptable salts are for example acid addition salts and basic salts.

Those of skill in the art will understand that modifications (additions and/or removals) of various components of the APIs, formulations, apparatuses, methods, systems and embodiments described herein may be made without departing from the full scope and spirit of the present invention, which encompass such modifications and any and all equivalents thereof.

An example drug delivery device may involve a needle-based injection system as described in Table 1 of section 5.2 of ISO 11608-1:2014(E). As described in ISO 11608-1:2014(E), needle-based injection systems may be broadly distinguished into multi-dose container systems and single-dose (with partial or full evacuation) container systems. The container may be a replaceable container or an integrated non-replaceable container.

As further described in ISO 11608-1:2014(E), a multi-dose container system may involve a needle-based injection device with a replaceable container. In such a system, each container holds multiple doses, the size of which may be fixed or variable (pre-set by the user). Another multi-dose container system may involve a needle-based injection device with an integrated non-replaceable container. In such a system, each container holds multiple doses, the size of which may be fixed or variable (pre-set by the user).

As further described in ISO 11608-1:2014(E), a single-dose container system may involve a needle-based injection device with a replaceable container. In one example for such a system, each container holds a single dose, whereby the entire deliverable volume is expelled (full evacuation). In a further example, each container holds a single dose, whereby a portion of the deliverable volume is expelled (partial evacuation). As also described in ISO 11608-1:2014(E), a single-dose container system may involve a needle-based injection device with an integrated non-replaceable container. In one example for such a system, each container holds a single dose, whereby the entire deliverable volume is expelled (full evacuation). In a further example, each container holds a single dose, whereby a portion of the deliverable volume is expelled (partial evacuation).

1-15. (canceled)

16. A computer implemented method of identifying one or more regions of interest in an image, the method comprising:
receiving a pair of images of a subject, the pair of images comprising an image of the subject and a luminescent image of the subject;
generating, using a first machine-learned model and from the image of the subject, coordinates of a bounding box around the subject in the image;
extracting, from the image of the subject and the luminescent image of the subject and based on the coordinates of the bounding box around the subject, a pair of cropped images, the pair of cropped images comprising a cropped image of the subject and a cropped luminescent image of the subject; and
generating, using a second machine learning model and from the pair of cropped images, parameters of a bounding shape identifying a region of interest,
wherein the second machine learning model is a neural network comprising:
one or more convolutional layers configured to generate a first feature map encoding features of the cropped image and a second feature map encoding features of the cropped luminescent image; and
one or more fully connected layers configured to transform the first feature map and the second feature map into the parameters of the bounding shape identifying the region of interest.

17. The method of claim 16, further comprising, after generating the first machine-learned model, using a thresholding algorithm to produce a mask which identifies contours of the subject within the bounding box.

18. The method of claim 16, wherein the second machine learning model further comprises one or more residual connections.

19. The method of claim 16, wherein the parameters of a bounding shape comprise parameters of an ellipse or circle.

20. The method of claim 19, wherein the parameters of the ellipse are:
(i) an x axis position of a centre point;
(ii) a y axis position of the centre point;
(iii) a length of the semi-minor axis;
(iv) a length of the semi-major axis; and
(v) an angle of rotation of the ellipse from vertical.

21. The method of claim 16, wherein the subject is an animal.

22. The method of claim 16, further comprising selecting a region of interest category from a list of anatomical regions, wherein the second machine learning model corresponds to the selected region of interest category.

23. The method of claim 16, further comprising, prior to generating the first feature map and the second feature map, checking if the image and the luminescent image are of a predetermined size, and if not, resizing the image and the luminescent image to the predetermined size.

24. The method claim 16, further comprising, displaying the image of the subject and/or the luminescent image of the subject with the region of interest indicated.

25. The method of claim 16, wherein the image is a photographic image of the subject.

26. The method of claim 16, further comprising, prior to transforming the first feature map and the second feature map, concatenating the first and second feature maps.

27. A computer implemented method of training a model for identifying one or more regions of interest in an image, the method comprising:
for each of a plurality of training samples, each training sample comprising: a training pair comprising an image of a subject and a luminescent image of the subject, and ground truth parameters of a bounding shape identifying a region of interest of the subject:
generating, using a neural network and from a respective training pair, candidate parameters of a bounding shape identifying the region of interest; and
comparing the candidate parameters of the bounding shape to corresponding ground truth parameters of the bounding shape of the training sample; and
updating parameters of the neural network based on the comparisons,
wherein the neural network comprises:
one or more convolutional layers configured to generate a first feature map encoding features of the image and a second feature map encoding features of the luminescent image; and
one or more fully connected layers configured to transform the first feature map and the second feature map into candidate parameters of a bounding shape identifying the region of interest.

28. The method of claim 27 wherein:
comparing the candidate parameters of the bounding shape to corresponding ground truth parameters of the bounding shape of the training sample comprises evaluating a loss function; and
updating parameters of the neural network based on the comparisons comprises applying an optimization routine to the loss function.

29. The method of claim 27, wherein the subject is an animal.

30. A system comprising:
one or more processors; and
a memory, the memory storing computer readable instructions that, when executed by the one or more processors, causes the system to:
receive a pair of images of a subject, the pair of images comprising an image of the subject and a luminescent image of the subject;
generate, using a first machine-learned model and from the image of the subject, coordinates of a bounding box around the subject in the image;
extract, from the image of the subject and the luminescent image of the subject and based on the coordinates of the bounding box around the subject, a pair of cropped images, the pair of images comprising a cropped image of the subject and a cropped luminescent image of the subject; and
generate, using a second machine learning model and from the pair of cropped images, parameters of a bounding shape identifying a region of interest, wherein the second machine learning model is a neural network comprising:
one or more convolutional layers configured to generate a first feature map encoding features of the cropped image and a second feature map encoding features of the cropped luminescent image; and
one or more fully connected layers configured to transform the first feature map and the second feature map into the parameters of the bounding shape identifying the region of interest.

31. The system of claim 30, further comprising, after the one or more processors cause the system to generate the first machine-learned model, using a thresholding algorithm to produce a mask which identifies contours of the subject within the bounding box.

32. The system of claim 30, wherein the second machine learning model further comprises one or more residual connections.

33. The system of claim 30, wherein the parameters of a bounding shape comprise parameters of an ellipse or circle.

34. The system of claim 30, wherein the parameters of the ellipse are:
(i) an x axis position of a centre point;
(ii) a y axis position of the centre point;
(iii) a length of the semi-minor axis;
(iv) a length of the semi-major axis; and
(v) an angle of rotation of the ellipse from vertical.

35. The system of claim 30, wherein the subject is an animal.
